(19) United States
(12) Patent Application Publication
(10) Pub. No.: US 2012/0319641 A1
(43) Pub. Date: Dec. 20, 2012

(54) Endless Miles

(76) Inventor: Carl Hero, Lago Vista, TX (US)

(21) Appl. No.: 13/473,158

(22) Filed: May 16, 2012

Related U.S. Application Data
(60) Provisional application No. 61/498,014, filed on Jun. 17, 2011.

(51) Int. Cl. H02J 7/00

(52) U.S. Cl. 320/101

(57) ABSTRACT

An architecture is presented that provides an air induction component for charging a battery and powering an electric motor. The air induction component comprises a first opening, a second opening, and a housing. Further, an air powered turbine assembly comprising a hub and a plurality of vanes, is mounted within the housing. An electrical generator assembly is positioned in electrical communication with the first opening of the air induction component, and is coupled to the turbine assembly. The electrical generator assembly comprises an electric motor and/or battery. In operation, airflow asserts a force on the plurality of vanes, which causes rotation of the turbine assembly, which in turn causes the electrical generator assembly to generate electrical current which is supplied to the electric motor and/or the electric battery. Typically, a pair of air induction components are utilized, with one air induction component being positioned on each side of a vehicle.

### CROSS-REFERENCE

This application claims priority from Provisional Patent Application Ser. No. 61/498,014 filed Jun. 17, 2011.

### BACKGROUND

Although great advances have been made in recent years in powering vehicles using alternative methods, such as hydrogen, electricity, solar power, and other renewable resources, consumers are still unable to purchase a vehicle that is completely powered by electricity. Hybrid models that are currently available on the market still require the use of gasoline. Furthermore, there are a few electric models that consumers can purchase, but these vehicles are powered by batteries which must be charged frequently at stationary charging stations. Typically, users can only travel for a few hundred miles before they must plug their electric vehicles into a charging station. A more efficient alterative is needed.

There is a need for a system designed to recharge power systems on electric driven or hybrid vehicles, such as cars and motorcycles. The present invention discloses a system of charging and powering an electric motor. The system comprises an air induction component that utilizes an air powered turbine assembly. While the vehicle is in motion, wind will pass through the turbine assembly's fan blades, which will generate power to recharge the vehicle's batteries or power cells. This system may be used on any electric driven or hybrid vehicle to provide energy. This eco-friendly product helps to eradicate exhaust emissions, and eliminates the need for a user to constantly plug the vehicle in for recharging, change the oil, or stop for gas. Consumers will appreciate the convenience and efficiency that this product affords.

### SUMMARY

The following presents a simplified summary in order to provide a basic understanding of some aspects of the disclosed innovation. This summary is not an extensive overview, and it is not intended to identify key/critical elements or to delineate the scope thereof. Its sole purpose is to present some concepts in a simplified form as a prelude to the more detailed description that is presented later.

The subject matter disclosed and claimed herein, in one aspect thereof, comprises an air induction component for charging the battery and powering an electric motor. The air induction component comprises a first opening, a second opening, and a housing. Further, an air powered turbine assembly is mounted within the housing. The air powered turbine assembly comprises a hub and a plurality of vanes extending radially from the hub. Additionally, an electrical generator assembly is positioned in electrical communication with the first opening of the air induction component. Specifically, the turbine assembly is coupled to the electrical generator assembly. The electrical generator assembly comprises an electric motor and/or an electric battery. In operation, airflow engages and asserts a force on the plurality of vanes, which causes rotation of the turbine assembly, which in turn will turn the drive shaft of the electrical generator assembly, causing the electrical generator assembly to generate electrical current which is supplied to either, or both of the electric motor and/or the electric battery.

Furthermore in the preferred embodiment of the present invention, a pair of air induction components are utilized, with one air induction component being positioned on each side of a vehicle. Typically, one air induction component will power the electric motor, which will in turn run the transmission and operate the vehicle, and the other air induction component will charge the electric battery. Additionally, a solar cell can be positioned on either or both sides of the vehicle, in electrical communication with the electrical generator assembly to help keep the charge when the vehicle is not running.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and is intended to include all such aspects and their equivalents. Other advantages and novel features will become apparent from the following detailed description when considered in conjunction with the drawings.

### BRIEF DESCRIPTION OF THE DRAWINGS

FIG. 1 illustrates a perspective view of an air induction component for charging and powering an electric motor in accordance with the disclosed architecture.

FIG. 2 illustrates a side, cross-sectional view of the air induction component in accordance with the disclosed architecture.

FIG. 3 illustrates a perspective view of a motorcycle with the air induction components positioned on either side in accordance with the disclosed architecture.

FIG. 4 illustrates a side, perspective view of a motorcycle with the air induction component and a solar cell positioned on the side in accordance with the disclosed architecture.

FIG. 5 illustrates a side, perspective view of a user riding a motorcycle containing the air induction component and the solar cell in accordance with the disclosed architecture.

### DESCRIPTION OF PREFERRED EMBODIMENTS

The innovation is now described with reference to the drawings, wherein like reference numerals are used to refer to like elements throughout. In the following description, for purposes of explanation, numerous specific details are set forth in order to provide a thorough understanding thereof. It may be evident, however, that the innovation can be practiced without these specific details. In other instances, well-known structures and devices are shown in block diagram form in order to facilitate a description thereof.

The present invention discloses a system of charging and powering an electric motor. The system comprises an air induction component that utilizes an air powered turbine assembly. While the vehicle is in motion, wind will pass through the turbine assembly's fan blades, which will generate power to the batteries or power cells. Typically, two air induction components are utilized, with one air induction component being positioned on either side of a vehicle. One air induction component will operate the vehicle while the other air induction component recharges the batteries. The system allows users to drive for longer periods of time without stopping to recharge their vehicle or fill-up with gasoline. This system may be used on any electric driven vehicle to provide energy, such as electric cars, sport utility vehicles (SUVs), motorcycles, gas powered hybrid vehicles, etc.

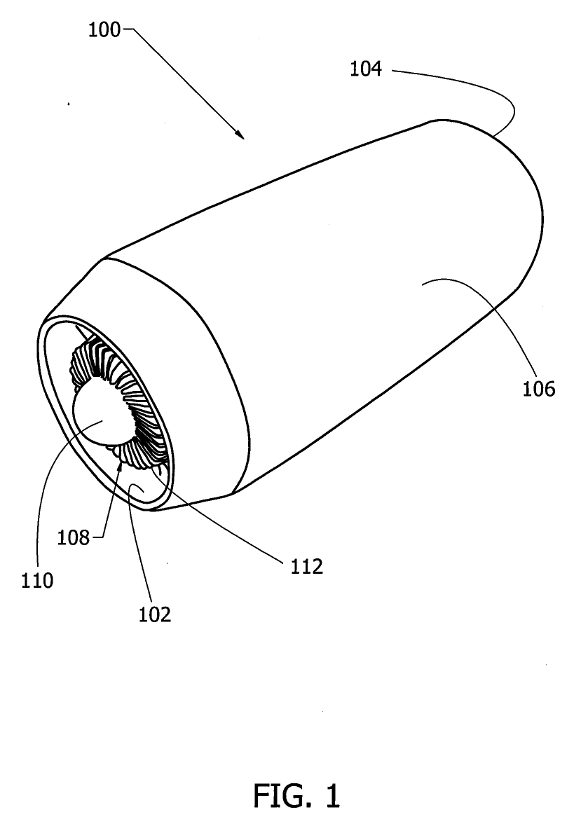

Referring initially to the drawings, FIG. 1 illustrates a perspective view of an air induction component 100 for charging and powering an electric motor. The air induction component 100 comprises a first opening 102, a second opening 104, and a housing 106. Typically, the air induction component 100 is generally cylindrical, however any other suitable shape, such as an oval, a rectangle, etc., can be used as is known in the art without affecting the overall concept of the invention. The air induction component 100 would generally be constructed of polycarbonate, acrylic, or high-performance plastics, though any other suitable material may be used to manufacture the air induction component 100 as is known in the art without affecting the overall concept of the invention. The air induction component 100 is approximately between 18 and 24 inches in length as measured from first opening 102 to second opening 104, and approximately between 8 and 10 inches in diameter, with the thickness of the component 100 being dependent on the material used to fabricate the air induction component 100. These dimensions would service a vehicle that weighs from 450-800 lbs., and would produce enough power to keep a battery at full charge for the operation of the vehicle, while the vehicle is in motion. Furthermore, the measurements would vary depending on the size and shape of the air induction component 100.

Additionally, the air induction component 100 would be secured to the frame of the vehicle via a cannon plug or any other suitable device as is known in the art without affecting the overall concept of the invention. The air induction component 100 can then be easily removed for repair or replaced with another unit. Further, the angle of the air induction component 100 is determined by the manufacture's angle of the front fork of the vehicle. The air induction component 100 should be attached in such a way as to get full advantage of wind deflection, and should not interfere with the turning of the front wheel or the operation of the brake pedal. Each and every vehicle model has its own turning radius, and the air induction component 100 would be sized for these modified versions.

Furthermore, an air powered turbine assembly 108 is mounted within the housing 106. The air powered turbine assembly 108 is of conventional design and construction as is known in the art. Specifically, the air powered turbine assembly 108 comprises a hub 110 and a plurality of angled vanes 112 (or fan blades) extending radially from the hub 110. The turbine assembly 108 can have any number of vanes 112 depending upon the specific rotation characteristics desired. Each of the plurality of vanes 112 is fixedly attached to the hub 110, and extends radially from the hub 110. The vanes 112 are evenly spaced along a circumference of the hub 110. During use, airflow will enter the first opening 102 of the air induction component 100, pass through housing 106, and exit out through second opening 104. The airflow engages the plurality of vanes 112 to exert a force on the plurality of vanes 112, which causes rotation of the turbine assembly 108. The size of the air powered turbine assembly 108 is dependent on the weight and configuration of the vehicle, with larger air powered turbine assemblies needed for larger or heavier vehicles.

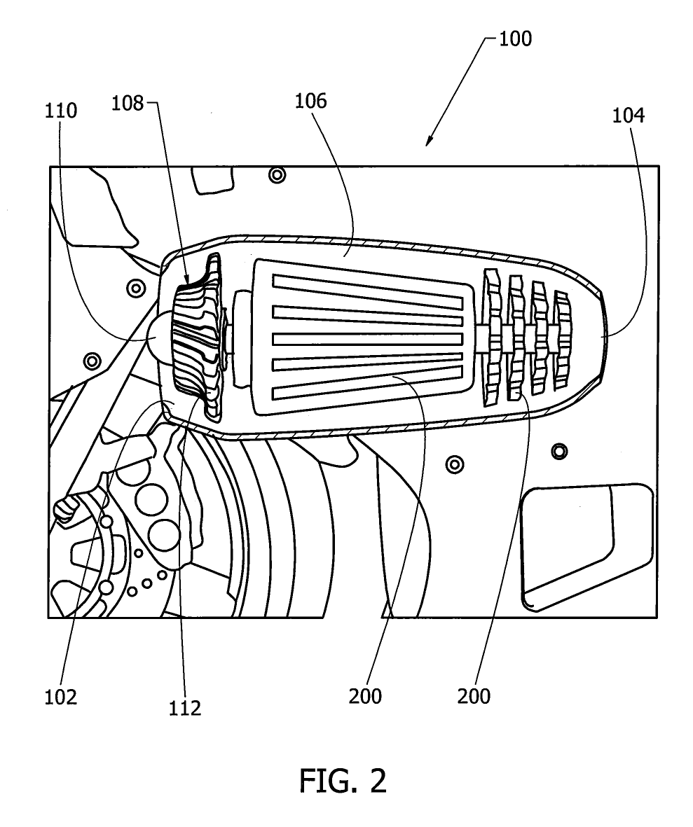

FIG. 2 illustrates a side, cross-sectional view of the air induction component 100. The air induction component 100 comprises a first opening 102, a second opening 104, and a housing 106. Further, an air powered turbine assembly 108 is mounted within the housing 106. The air powered turbine assembly 108 comprises a hub 110 and a plurality of vanes 112 extending radially from the hub 110. The housing 106 can also encase a plurality of airflow directors or guides 200. The air guides 200 direct the airflow from the turbine assembly 108 to a respective air inlet channel of the housing 106 and allow the airflow to exit out through second opening 104.

Additionally, an electrical generator assembly, of conventional design and construction as is known in the art, is positioned in electrical communication with the first opening 102 of the air induction component 100. Specifically, the turbine assembly 108 is electrically coupled to the electrical generator assembly. The electrical generator assembly comprises an electric motor and/or an electric battery of conventional design and construction as is known in the art. Airflow engages and asserts a force on the plurality of vanes 112, which causes rotation of the turbine assembly 108, which in turn would turn the drive shaft of the electrical generator, and cause the electrical generator assembly to generate electrical current which is carried through cables into a voltage regulator, then electricity is supplied to either, or both of the electric motor and/or the electric battery. Specifically, instead of having a fan belt, the force of the air through turbine blades will excite the air induction assembly 100 causing it to operate and manufacture electricity. Accordingly, the air induction component 100 is configured to receive airflow through the first opening 102, wherein airflow passing through the air induction component will generate electricity and power an electric motor and/or charge an electric battery.

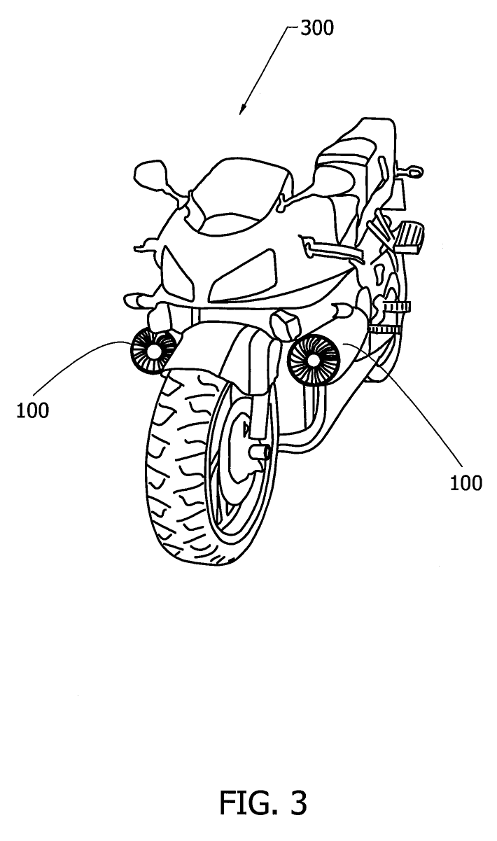

FIG. 3 illustrates a perspective view of a motorcycle 300 with the air induction components 100 positioned on either side. Typically, a vehicle such as a motorcycle or car, or any other electrically-powered vehicle, or hybrid vehicle, as is known in the art would have two air induction components 100 to power the vehicle. Generally, the two air induction components 100 are positioned on opposite sides of the vehicle. For example, FIG. 3 illustrates an air induction component 100 on each side of the motorcycle 300, near the fork of the motorcycle 300 for balance. On a car or other similarly shaped vehicle, the air induction components 100 would be positioned on opposite side panels, and/or on the hood of the car. The air induction components 100 can also occupy the space of the car's radiator, as a radiator would not be needed for an electric car or hybrid, and the configuration of the car would not have to change. Any number of air induction components 100 can be used as is known in the art, depending on the wants and needs of a user and, possibly, the size and weight of the vehicle. Further, air induction components 100 may be formed as an integral portion of a vehicle's side panel (or hood), or a motorcycle's fork. In contrast, the air induction components 100 may be fixedly attached to the side panel and/or fork via fastening hardware or gluing, or any other suitable means of attaching as is known in the art.

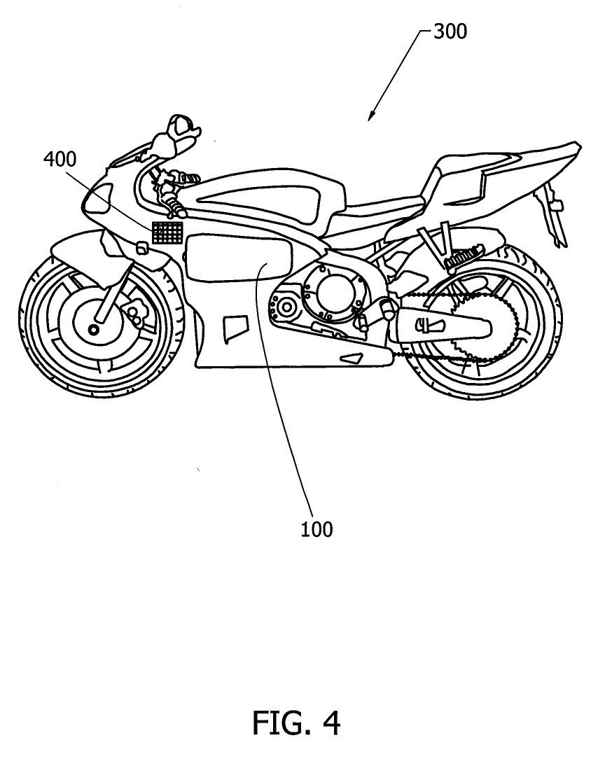

FIG. 4 illustrates a side, perspective view of a motorcycle 300 with the air induction component 100 and a solar cell 400 positioned on either or both sides of the motorcycle 300. Specifically, at least one solar cell can be positioned in electrical communication with the electrical generator assembly. Except for modifications made to accommodate the air induction component 100, the solar cell 400 may be of conventional design and construction as is known in the art. The solar cell 400 is positioned in communication with the electrical generator assembly to help keep the charge when the vehicle is not running.

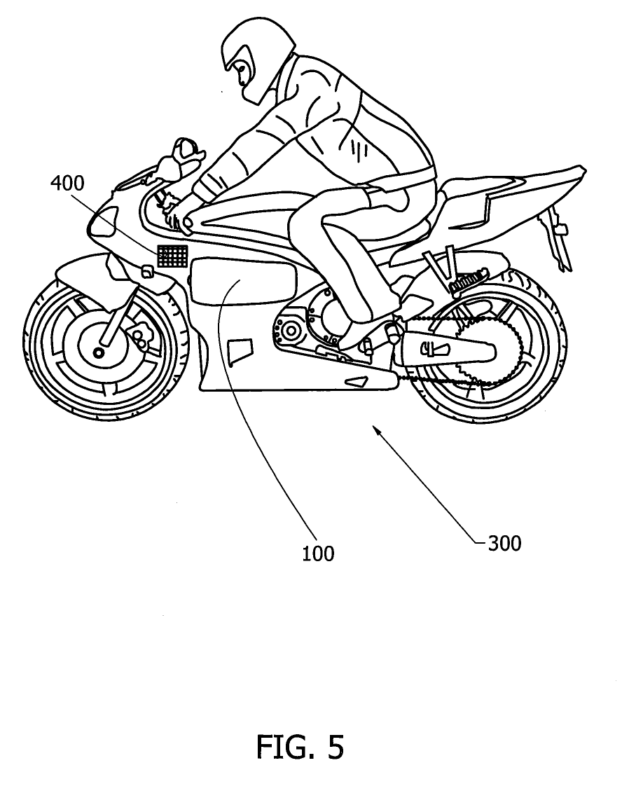

FIG. 5 illustrates the air induction component 100 in use. In operation, at least one air induction component 100 is fixedly attached (or is formed as an integral portion) to a vehicle (i.e., a motorcycle 300). In a preferred embodiment, two air induction components 100 are fixedly attached to a vehicle, one on each side of the vehicle. A user then operates the vehicle normally (i.e., drives the vehicle). The air induction components 100 will draw in the passing airflow, and the forced air passing through induction components 100 will exert a force against the vanes of the turbine assembly. This exerted force against the vanes of the turbine assembly will cause rotation of the turbine assembly. Air guides will then direct the airflow from the turbine assembly to a respective air inlet channel of the housing and allow the airflow to exit out through the second opening.

Airflow through the air induction components 100 causes the electrical generator assembly to generate electrical current which is supplied to either, or both of the electric motor and/or the electric battery. Specifically, airflow engages and asserts a force on the plurality of vanes of the turbine assembly, which causes rotation of the turbine assembly, which in turn would turn the drive shaft of the electrical generator, and cause the electrical generator assembly to generate electrical current which is carried through cables into a voltage regulator, then electricity is supplied to either, or both of the electric motor and/or the electric battery. Typically, both air induction components will work simultaneously to power the electric motor, which will in turn run the transmission and operate the vehicle, and will charge the electric battery. Thus the air induction components operate simultaneously to power the vehicle. However, in an emergency, one air induction component could produce enough electricity to operate the vehicle until maintenance could be performed. As speed of transportation increases, the output of the turbines will increase. Further, the speed at which the turbines will operate at full capacity would be determined by the pitch of the blades, with normal speed of the blades being 15 to 20 mph. Thus, as the vehicle moves, it will generate wind, which will create electrical current and will charge the batteries and power the motor. Furthermore, a solar cell 400 can be positioned in communication with the electrical generator assembly to help keep the charge when the vehicle is not running.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A system for charging a battery and powering an electric motor comprising:
at least one air induction component comprising a first opening and a housing, wherein the at least one air induction component is configured to receive an airflow through the first opening; and
an electrical generator assembly in electrical communication with the first opening of the at least one air induction component; and
wherein air passing through the at least one air induction component will generate electricity.

2. The system of claim 1, wherein the at least one air induction component comprises an air powered turbine assembly mounted within the housing.

3. The system of claim 2, wherein the air powered turbine assembly comprises a hub and a plurality of vanes extending radially from the hub.

4. The system of claim 2, wherein the air powered turbine assembly is coupled to the electrical generator assembly.

5. The system of claim 1, wherein the electrical generator assembly comprises an electric motor.

6. The system of claim 1, wherein the electrical generator assembly comprises an electric battery.

7. The system of claim 1, further comprising at least one solar cell in communication with the electrical generator assembly.

8. The system of claim 1, further comprising a second air induction component comprising a first opening and a housing, wherein the second air induction component is configured to receive an airflow through the first opening.

9. The system of claim 8, wherein the at least one air induction component and the second air induction component are positioned on opposite sides of a motorcycle.

10. The system of claim 8, wherein the at least one air induction component and the second air induction component are positioned on opposite side panels of a vehicle.

11. A system for charging a battery and powering an electric motor assembly comprising:
at least one air induction component comprising a first opening and a housing, wherein the at least one air induction component is configured to receive an airflow through the first opening;
an air powered turbine assembly mounted within the housing; and
an electrical generator assembly in electrical communication with the first opening of the at least one air induction component; and
wherein air passing through the at least one air induction component will generate electricity.

12. The system of claim 11, wherein the air powered turbine assembly is coupled to the electrical generator assembly.

13. The system of claim 11, wherein the electrical generator assembly comprises an electric motor.

14. The system of claim 11, wherein the electrical generator assembly comprises an electric battery.

15. The system of claim 11, wherein the air powered turbine assembly comprises a hub and a plurality of vanes extending radially from the hub.

16. The system of claim 11, further comprising at least one solar cell in communication with the electrical generator assembly.

17. The system of claim 11, further comprising a second air induction component, wherein the at least one air induction component and the second air induction component are positioned on opposite sides of a vehicle.

18. A system for charging a battery and powering an electric motor assembly comprising:
a first air induction component comprising a first opening, a housing, and an electrical motor in electrical communication with the first opening, wherein the first air induction component is configured to receive an airflow through the first opening which will generate electricity for the electrical motor; and
a second air induction component comprising a first opening, a housing and an electrical battery in electrical communication with the first opening, wherein the second air induction component is configured to receive an airflow through the first opening which will generate electricity for the electrical battery.

19. The system of claim 18, wherein the first and the second air induction components each comprise an air powered turbine assembly mounted within the housing of the first and the second air induction components.

20. The system of claim 19, wherein the air powered turbine assembly comprises a hub and a plurality of vanes extending radially from the hub.
